(19) United States
(12) Patent Application Publication
(10) Pub. No.: US 2018/0115207 A1
(43) Pub. Date: Apr. 26, 2018

(54) ROTOR OF A ROTARY ELECTRICAL MACHINE WITH OPTIMISED IMPLANTATION OF SECURING MEANS

(71) Applicant: VALEO EQUIPEMENTS ELECTRIQUES MOTEUR, Creteil Cedex (FR)

(72) Inventors: Benoit WALME, Feucherolles (FR); Mamy RAKOTOVAO, Vitry Sur Seine (FR); Nam-Gook KIM, Saint-maurice (FR)

(21) Appl. No.: 15/557,884

(22) PCT Filed: Feb. 19, 2016
(86) PCT No.: PCT/FR2016/050380

§ 371 Date: Sep. 13, 2017

(30) Foreign Application Priority Data
Mar. 16, 2015 (FR) 1552140

(51) Int. Cl. H02K 1/28; H02K 1/27

(52) U.S. Cl. CPC H02K 1/28; H02K 2213/03; H02K 1/276

(57) ABSTRACT

The invention relates mainly to a rotor (10) of a rotary electric machine having an axis of rotation (X) and including: a rotor body (11) made up of a packet of sheets, a set of permanent magnets (22), and a plurality of holes (13) made in the rotor body (11) in order to each allow the passage of a means (14) for attaching the sheets of the rotor body (11), wherein a ratio between a radial distance separating an axis of each attachment hole (13) relative to the rotation axis (X) and an external radius of the rotor body (11) is lower than 70%, in particular lower than 65%.

The invention relates to a rotor of a rotary electrical machine with optimised implantation of securing means.

In a known manner, rotary electrical machines comprise a stator and a rotor integral with a shaft. The rotor can be integral with a driving and/or driven shaft, and can belong to a rotary electrical machine in the form of an alternator, an electric motor, or a reversible machine which can operate in both modes.

The stator is fitted in a housing which is configured to rotate the shaft, for example by means of bearings. The stator comprises a body constituted by a stack of thin plates forming a crown, the inner face of which is provided with notches which are open towards the interior in order to receive phase windings. In a winding of a distributed undulating type, the windings are obtained for example from a continuous wire covered with enamel, or from conductive elements in the form of pins which are connected to one another by welding. Alternatively, in a winding of the “concentric” type, the phase windings are constituted by coils closed on themselves, which are wound around teeth of the stator. The protection between the set of plates and the winding wire is ensured either by an insulator of the paper type, or by plastic by overmoulding, or by means of an added-on part. These windings are polyphase windings connected in the form of a star or a triangle, the outputs of which are connected to control electronics.

In addition, the rotor comprises a body formed by a stack of sheets of plates which are maintained in the form of a set by means of an appropriate securing system, such as rivets which pass through the rotor axially from one side to another, or by means of clips or pegs. The rotor comprises poles formed by permanent magnets accommodated in cavities which are provided in the body of the rotor.

Rotary electrical machines are known which are coupled to a shaft of an electric turbocompressor. This electric turbocompressor makes it possible to compensate at least partly for the loss of power of the thermal engines with a reduced capacity used in many motor vehicles in order to reduce their consumption and the emissions of pollutant particles so-called downsizing principle). For this purpose, the electric turbocompressor comprises a turbine which is arranged on the inlet duct upstream or downstream from the thermal engine, in order to make it possible to compress the air, so as to optimise the filling of the cylinders of the thermal engine. The electrical machine is activated in order to drive the turbine, so as to minimise the torque response time, in particular during transitory phases in acceleration, or in the phase of automatic restarting of the thermal engine after it has been on standby (so-called stop and start operation). In view of the very small size of the rotor body, and the fact that a large part of its volume is occupied by the permanent magnets, the location of the means for securing of the plates on this type of rotor is problematic.

The invention proposes the configuration of a rotor provided with holes for the passage of the securing means, which guarantees the mechanical resistance of the plates, whilst disrupting as little as possible the electromagnetic performance of the rotor.

More specifically, the subject of the present invention is a rotor of a rotary electrical machine, in particular an electrical machine which can rotate at speeds of rotation of approximately 60,000 to 80,000 rpm, with an axis of rotation, and comprising:

a rotor body formed by a set of plates;

a set of permanent magnets; and

a plurality of holes provided in the said rotor body in order each to permit the passage of a means for securing of the plates of the said rotor body, characterised in that a ratio between a radial distance which separates an axis of each securing hole relative to the said axis of rotation and an outer radius of the said rotor body, is less than 70%, and in particular less than 65%.

Positioning of this type of the securing holes makes it possible, with a reduced number of corresponding securing means, to obtain an optimised magnetic flux in all of the parts of the rotor body, and to guarantee the mechanical resistance of the rotor.

According to one embodiment, each securing hole is arranged angularly between two permanent magnets.

A configuration of this type is particularly suitable for permitting good mechanical resistance, in particular for electrical machines with speeds of rotation of approximately 60,000 to 80,000 rpm, and having a magnet volume which is large relative to the volume of the set of plates.

According to one embodiment, a radius of the rotor which intersects a securing hole does not intersect any one of the permanent magnets of the rotor.

According to one embodiment, each securing hole has a cross-section which is round, square or rectangular.

According to one embodiment, in a given radial direction which passes via the said axis of rotation of the said rotor and an axis of a securing hole, the said rotor body comprises a single securing hole.

According to one embodiment, the said rotor body comprises a plurality of cavities which each accommodate at least one permanent magnet of the said set of permanent magnets.

According to one embodiment, each cavity opens from one side of the rotor body to the other.

According to one embodiment, the said rotor comprises a single permanent magnet or a plurality of permanent magnets per cavity.

According to one embodiment, two adjacent cavities are separated by an arm which belongs to the said rotor body.

According to one embodiment, each securing hole comprises an edge situated at a first smaller distance from a first adjacent cavity, and at a second smaller distance from a second adjacent cavity, a sum of the first and the second distances being greater than a thickness of an arm, this minimum thickness being approximately 1.5 mm, the thickness of an arm being measured in an orthoradial direction.

According to one embodiment, the said rotor body comprises as many securing holes as there are arms.

According to one embodiment, each securing hole is positioned on a plane of symmetry of an arm.

According to one embodiment, the said rotor body is without a securing hole in an external strip of material which has a width equal to at least 15%, and in particular equal to at least 17%, of the outer diameter of the rotor.

According to one embodiment, the said securing holes are positioned substantially on the same circumference of the said rotor body.

According to one embodiment, the said permanent magnets have radial magnetisation.

According to one embodiment, an angular opening of each permanent magnet is equal to at least 30°, and in particular more than 45°.

According to one embodiment, the said permanent magnets are made of rare earth.

According to one embodiment, an outer diameter of the said rotor body is between 20 mm and 50 mm, in particular between 24 mm and 34 mm, and is preferably approximately 28 mm. This diameter complies with a physical rule which imposes a given maximum diameter according to the maximum speed, in order not to exceed a critical linear speed.

According to one embodiment, the rotor body has an outer periphery with a cylindrical face substantially in the form of that of a cylinder of revolution.

A rotor of this type makes it possible to increase the inductance (Lq) on the axis which passes between the permanent magnets. This makes it possible to obtain a reluctant torque, which participates in the production of the engine torque at high speed. This is particularly suitable for electrical machines which rotate at high speed, i.e. speeds of at least 40,000 rpm.

According to one embodiment, the rotor comprises four poles.

The invention also relates to a rotary electrical machine comprising a wound stator and a rotor as previously defined.

The wound stator can comprise a concentric winding. This type of winding makes it possible to obtain shorter cycle times than with a distributed winding.

According to one embodiment, the said machine has a response time of between 100 ms and 600 ms, in particular between 200 ms and 400 ms, for example being approximately 250 ms in order to go from 5,000 to 70,000 rpm.

According to one embodiment, a voltage of use is 12 V and a steady state current is approximately 150 A.

Preferably, the rotary electrical machine can provide a current spike of between 150 A and 300 A, in particular between 180 A and 220 A.

According to one embodiment, an outer diameter of the stator is between 35 mm and 80 mm, in particular between 45 mm and 55 mm, for example between 48 mm and 52 mm. This diameter has been defined taking as a constraint firstly a volume of size of the turbocompressor not to be exceeded, and secondly the constraint of feasibility of the process in order to ensure a concentric winding, imposing a minimum inner stator diameter in order to be able to make the arm of the winding needle pass.

The invention will be better understood by reading the following description and examining the figures which accompany it. These figures are provided purely by way of illustration, and in no way limit the invention.

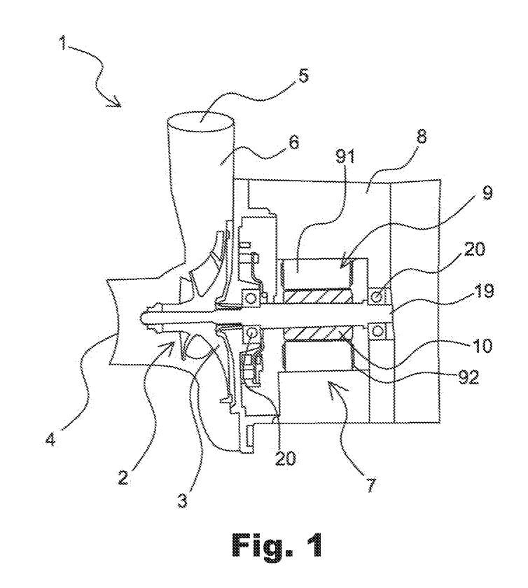

FIG. 1 is a view in cross-section of a turbocompressor comprising a rotary electrical machine according to the present invention;

FIG. 2 shows a view in perspective of the rotor of the rotary electrical machine according to the present invention;

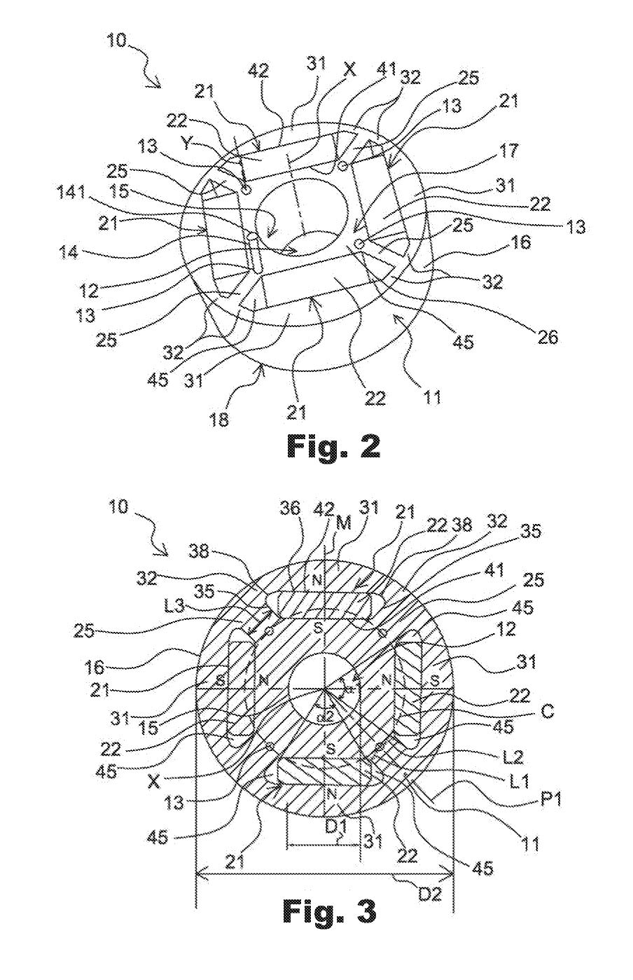

FIG. 3 is a view in transverse cross-section of the rotor of the rotary electrical machine according to the present invention;

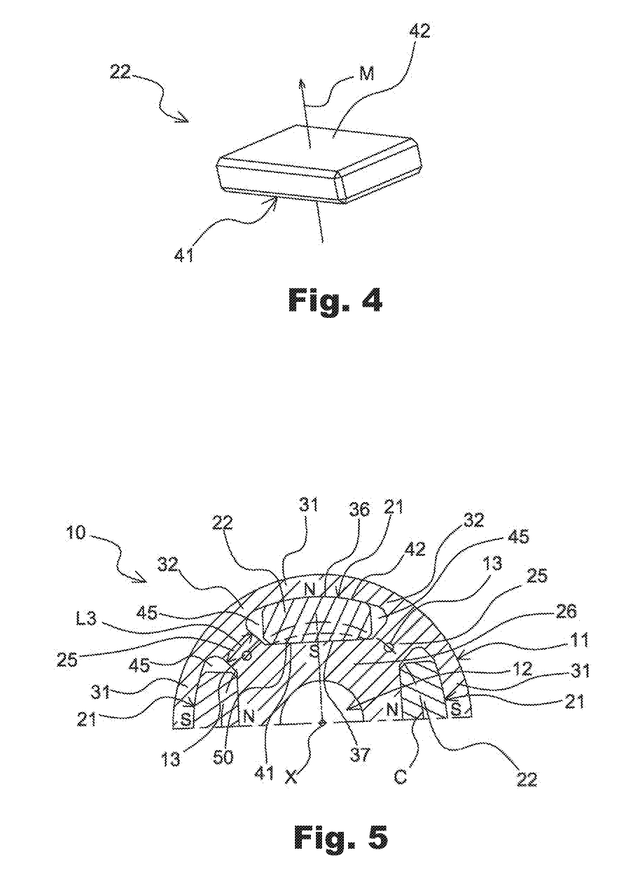

FIG. 4 is a view in perspective of a permanent magnet which is designed to be inserted inside a cavity in the rotor according to the present invention;

FIG. 5 shows a view in partial cross-section illustrating a variant embodiment of the rotor of the electrical machine according to the present invention.

Elements which are identical, similar or analogous retain the same reference from one figure to another.

FIG. 1 shows a turbocompressor 1 comprising a turbine 2 provided with fins 3 which can aspirate via an inlet 4 non-compressed air obtained from a source of air (not represented) and deliver compressed air compressed air via the outlet 5 after passage into a volute with the reference 6. The outlet 5 can be connected to an inlet distributor (not represented) situated upstream or downstream from the thermal engine, in order to optimise the filling of the cylinders of the thermal engine. In this case, the air is aspirated in an axial direction, i.e. according to the axis of the turbine 2, and the delivery is carried out in a radial direction perpendicular to the axis of the turbine 2. As a variant, the aspiration is radial, whereas the delivery is axial. Alternatively, the aspiration and the delivery are carried out in the same direction relative to the axis of the turbine (axial or radial).

For this purpose, the turbine 2 is driven by an electrical machine 7 which is fitted inside the housing 8. This electrical machine 7 comprises a stator 9, which can be polyphase, surrounding a rotor 10 with the presence of an air gap. This stator 9 is fitted in the housing 8 which is configured to rotate a shaft 19 by means of bearings 20. The shaft 19 is connected in rotation to the turbine 2 as well as to the rotor 10. The stator 9 is preferably fitted in the housing 8 by banding.

In order to minimise the inertia of the turbine 2 during a demand for acceleration by the driver, the electrical machine 7 has a short response time of between 100 ms and 600 ms, in particular between 200 ms and 400 ms, for example approximately 250 ms, in order to go from 5,000 to 70,000 rpm. Preferably, the voltage of use is 12 V, and a steady state current is approximately 150 A. Preferably, the electrical machine 7 can provide a current spike, i.e. a current which is supplied for a continuous duration of less than three seconds, of between 150 A and 300 A, in particular between 180 A and 220 A. As a variant, the electrical machine 7 can operate in alternator mode, or is an electrical machine of a reversible type.

More specifically, the stator 9 comprises a body 91 constituted by a stack of thin plates forming a crown, the inner face of which is provided with notches which are open towards the interior in order to receive phase windings of a winding 92. In a winding of the distributed undulating type, the windings are obtained for example from a continuous wire covered with enamel, or from conductive elements in the form of pins which are connected to one another by welding. Alternatively, in a winding of the “concentric” type, the phase windings are constituted by coils closed on themselves, which are wound around teeth of the stator 9. The protection between the set of plates and the winding wire is ensured either by an insulator of the paper type, or by plastic by overmoulding, or by means of an added-on part. These windings are polyphase windings connected in the form of a star or a triangle, the outputs of which are connected to control electronics.

In addition, the rotor 10 with an axis of rotation X shown in detail in FIG. 2 has permanent magnets. The rotor 10 comprises a rotor body 11 formed in this case by a stack of plates which extend on a radial plane perpendicular to the axis X, in order to decrease the Foucault currents. This rotor body 11 is made of ferromagnetic material. The plates are retained by securing means 14, for example rivets, which pass through the stack of plates axially from one side to the other, or with clips, or also by means of pegs, in order to form an assembly which can be handled and transported.

For this purpose, a plurality of securing holes 13 are provided in the rotor body 11 in order each to permit the passage of a means 14 for securing of the plates of the rotor body 11. In this case, each hole 13 has a round cross-section, and has a diameter of approximately 1.5 mm. In addition, the securing holes 13 are preferably through holes, i.e. they open axially onto each of the axial ends 17, 18 of the rotor body 11, such that it is possible to pass inside each hole 13 a rod 14 which is provided with a head 141 at one of its ends, and the other end of which will be deformed, for example by a heading process, in order to ensure the axial retention of the set of plates. As a variant, the rod 14 is without a head 141, and the two ends are then deformed by a heading process. As a variant, the holes 13 can have a cross-section with a square or rectangular form, or any other form which is suitable for the passage of the securing means 14.

The rotor body 11 can be connected in rotation to the shaft 19 in different ways, for example by force fitting of the ribbed shaft 19 inside the central opening 12 in the rotor 10, or by means of a key device.

The rotor body 11 has an inner periphery 15 which delimits the central cylindrical opening 12 with an inner diameter D1 for example of approximately 10 mm, and an outer periphery 16 which is delimited by a cylindrical face with an outer diameter D2 of between 20 mm and 50 mm, in particular between 24 mm and 34 mm, and preferably approximately 28 mm. The rotor body 11 also has two axial end faces 17, 18 with an annular form which extend between the inner periphery 15 and the outer periphery 16.

In addition, an outer diameter of the stator 9 is between 35 mm and 80 mm, in particular between 45 mm and 55 mm, for example between 48 mm and 52 mm.

The rotor 10 comprises a plurality of cavities 21, in each of which a permanent magnet 22 is accommodated. Each cavity 21 passes axially through the rotor body 11 from one side to the other, i.e. from one axial end face 17, 18 to the other. Two adjacent cavities 21 are separated by an arm 25 obtained from a core 26 of the rotor 10, such that there is alternation of cavities 21 and arms 25 when a circumference of the rotor 10 is followed. The rotor body 11 also comprises polar walls 31 which are each situated between two adjacent arms 25. Each polar wall 31 extends between an inner face 36 in contact with a permanent magnet 22 and the outer periphery of the rotor 10. In addition, each arm 25 is connected to a corresponding polar wall 31 by means of a bridge 32.

Thus, as can be seen in FIG. 3, the cavities 21 are each delimited by two faces 35 of two adjacent arms 25 facing towards one another, a flat inner face 36 of a polar wall 31 extending in an orthoradial direction, a flat face 37 provided in the core 26 parallel to the face 36, and the inner faces 38 of two bridges 32. The junctions between the faces 35 and 38 can be rounded in order to facilitate the production of the parts.

The preferred configuration of the securing holes 13 relative to that of the rotor 10 is described hereinafter. Preferably, a ratio between a radial distance which separates the axis Y of each hole 13 relative to the axis of rotation X and an outer radius (equal to D2/2) of the rotor body 11 is smaller than 70%, and in particular smaller than 65%. The securing holes 13 are positioned substantially on the same circumference of the rotor body 11, i.e. on a circle C which in the present case has a diameter of approximately 17 mm plus or minus 10% of this value.

In this embodiment, each hole 13 is arranged angularly between two consecutive permanent magnets 22. In other words, on a plane orthogonal to the axis, a plane which passes via the axis Y of a given hole 13 and the axis X does not intersect a permanent magnet 22. In a given radial direction which passes via the axis X of the rotor 10 and an axis Y of a hole 13, the rotor 10 comprises a single securing hole 13. This therefore minimises the number of securing means 14 used.

In addition, advantageously, each hole 13 comprises an edge which is situated at a first smaller distance L1 from a first adjacent cavity 21, and at a second smaller distance L2 from a second adjacent cavity 21, and a sum of the first L1 and the second L2 distances is greater than a minimum thickness L3 of an arm 25 measured in an orthoradial direction (cf. FIG. 3), this minimum thickness being approximately 1.5 mm. Taking into account the symmetry of the rotor body 11, the two distances L1 and L2 are substantially equal, but as a variant could be different.

Preferably, the rotor 10 comprises as many holes 13 as there are arms 25, and each hole 13 is preferably positioned on a plane of symmetry P1 of an arm 25 consisting of a plane with radial orientation which passes via the axis X, and separates the arm 25 into two substantially identical parts. In this case, the plane of symmetry P1 is equal to a plane of symmetry of the rotor body 11.

In order to optimise the magnetic performance of the rotor 10, the rotor body 11 is without a hole 13 in an external strip of material which has a width equal to at least 15%, and in particular equal to at least 17%, of the outer diameter D2 of the rotor 10.

In the present case, as can be seen clearly in FIG. 4, the permanent magnets 22 have a rectangular parallelepiped form, the angles of which are slightly bevelled. The magnets 22 thus have a substantially constant rectangular transverse cross-section. The magnets 22 have radial magnetisation, i.e. the two faces 41, 42 which are parallel to one another with orthoradial orientation are magnetised such as to be able to generate a magnetic flux according to an orientation M which is radial relative to the axis X. Amongst these parallel faces 41, 42 a distinction is made between the inner face 41 situated on the side of the axis X of the rotor 10, and the outer face 42 situated on the outer periphery side 16 of the rotor 10.

As can be seen clearly in FIGS. 3 and 5 where the letters N and S correspond respectively to the North and South poles, the magnets 22 which are situated in two consecutive cavities 21 have alternating polarities. Thus, from one cavity 21 to another, the inner faces 41 of the magnets 22 supported against the flat face 37 provided in the core 26 have alternating polarities, and the outer faces 42 of the magnets 22 in contact with the inner face 36 of the corresponding polar wall 31 have alternating polarities.

The inner 41 and outer 42 faces of each magnet 22 are in this case flat, like the other faces of each magnet 22. As a variant, as represented in FIG. 5, the outer face 42 of each magnet 22 is curved, whereas the inner face 41 of the magnet 22 is flat, or conversely. The inner face 36 of the polar wall 31 thus has a corresponding curved form. This therefore improves the retention of the magnet 22 inside a cavity 21. Alternatively, the two lateral faces 41 and 42 are curved in the same direction (cf. broken line 50), such that each magnet 22 has globally the form of a tile.

Also, the magnets 22 do not fill the cavities 21 completely, such that there are two empty spaces 45 on both sides of the magnet 22. The volume of air delimited by all of the spaces 45 of the rotor 10 make it possible to reduce the inertia of the rotor 10.

For this purpose, the angular opening α1 of a cavity 21 is larger than the angular opening α2 of a corresponding permanent magnet 22. The angular opening α1, α2 of a given element (cavity 21 or magnet 22) is defined by the angle formed by two planes which each pass via the axis X and via one of the ends of the said element. According to one embodiment, the angular opening α1 of each cavity 21 is strictly larger than 40°, whereas the angular opening α2 of a magnet 22 is at least 30°. The angular opening α2 of a magnet can be larger than 45°. According to a particular embodiment, the angular opening α1 of each cavity 21 is approximately 73°, whereas the angular opening α2 of a magnet 22 is approximately 67°.

The magnets 22 are preferably made of rare earth, in order to maximise the magnetic power of the machine 7. As a variant, they can however be made of ferrite, depending on the applications and the power required from the electrical machine 7. As an alternative, the magnets 22 can be of different grades in order to reduce the costs. For example, there is alternation in the cavities 21 of use of a rare earth magnet and a ferrite magnet which is less powerful but less costly. Certain cavities can also be left empty depending on the power required from the electrical machine 7. For example, two diametrically opposite cavities 21 can be empty. In this case, the number of cavities 21 is four, like the number of associated magnets 22. It is however possible to increase the number of cavities 21 and magnets 22 depending on the application.

In addition, a single permanent magnet 22 is inserted inside each cavity 21. As a variant, it is possible to use a plurality of magnets 22 stacked on one another inside a single cavity 21. It is possible for example to use two permanent magnets 22 stacked axially or orthoradially on one another, which magnets can if applicable have different grades.

Inside each cavity 21, the rotor 10 can also comprise a small plate (not represented) known as a laminette, made of material more flexible than the magnets 22. These small plates make it possible to facilitate the insertion of the magnets 22 in the cavities 21, which is carried out by making the magnets 22 slide parallel to the axis X of the rotor 10. This small plate can be replaced by an element for mechanical retention of the magnets, of the spring or pin type, or by an adhesive, in order to ensure the mechanical retention of the magnets.

The rotor body 11 can also comprise two retention plates (not represented) placed on both sides of the rotor 10 on its axial end faces. These retention plates ensure axial retention of the elements 22 inside the cavities 21, and are also used to balance the rotor. The flanges are made of non-magnetic material, for example aluminium.

It will be appreciated that the foregoing description has been provided purely by way of example, and does not limit the field of the invention, a departure from which would not be constituted by replacement of the different elements by any other equivalents.

1. Rotor (10) of a rotary electrical machine, in particular an electrical machine which can rotate at speeds of rotation of approximately 60,000 to 80,000 rpm, with an axis of rotation (X), and comprising:
a rotor body (11) formed by a set of plates;
a set of permanent magnets (22); and
a plurality of holes (13) provided in said rotor body (11) in order each to permit the passage of a means (14) for securing of the plates of said rotor body (11), wherein a ratio between a radial distance which separates an axis (Y) of each securing hole (13) relative to said axis of rotation (X) and an outer radius of said rotor body (11), is less than 70%, and in particular less than 65%.

2. Rotor according to claim 1, wherein each securing hole (13) is arranged angularly between two permanent magnets.

3. Rotor according to claim 1, wherein in a given radial direction which passes via said axis of rotation (X) of said rotor (10) and an axis (Y) of a securing hole (13), said rotor body (11) comprises a single securing hole (13).

4. Rotor according to claim 1, wherein said rotor body (11) comprises a plurality of cavities (21) which each accommodate at least one permanent magnet (22) of said set of permanent magnets (22).

5. Rotor according to claim 4, wherein two adjacent cavities (21) are separated by an arm (25) which belongs to said rotor body (11).

6. Rotor according to claim 5, wherein each securing hole (13) comprises an edge situated at a first smaller distance (L1) from a first adjacent cavity (21), and at a second smaller distance (L2) from a second adjacent cavity (21), a sum of the first (L1) and the second distances (L2) being greater than a thickness (L3) of an arm (25) measured in an orthoradial direction.

7. Rotor according to claim 5, wherein said rotor body (11) comprises as many securing holes (13) as there are arms (25).

8. Rotor according to claim 5, wherein each securing hole (13) is positioned on a plane of symmetry (P1) of an arm (25).

9. Rotor according to claim 1, wherein said rotor body (11) is without a securing hole (13) in an external strip of material which has a width equal to at least 15%, and in particular equal to at least 17%, of the outer diameter (D2) of the rotor (10).

10. Rotor according to claim 1, wherein said securing holes (13) are positioned substantially on the same circumference of said rotor body (11).

11. Rotor according to claim 1, wherein said permanent magnets (22) have radial magnetisation.

12. Rotor according to claim 1, wherein an angular opening (α2) of each permanent magnet (22) is equal to at least 30°, and in particular is equal to at least 45°.

13. Rotor according to claim 1, wherein an outer diameter (D2) of said rotor body (11) is between 20 mm and 50 mm, in particular between 24 mm and 34 mm, and is preferably approximately 28 mm.

14. Rotary electrical machine (7) comprising a wound stator and a rotor (10) as defined according to claim 1.

15. Rotor according to claim 2, wherein in a given radial direction which passes via said axis of rotation (X) of said rotor (10) and an axis (Y) of a securing hole (13), said rotor body (11) comprises a single securing hole (13).

16. Rotor according to claim 2, wherein said rotor body (11) comprises a plurality of cavities (21) which each accommodate at least one permanent magnet (22) of said set of permanent magnets (22).

17. Rotor according to claim 3, wherein said rotor body (11) comprises a plurality of cavities (21) which each accommodate at least one permanent magnet (22) of said set of permanent magnets (22).

18. Rotor according to claim 6, wherein said rotor body (11) comprises as many securing holes (13) as there are arms (25).

19. Rotor according to claim 6, wherein each securing hole (13) is positioned on a plane of symmetry (P1) of an arm (25).

20. Rotor according to claim 7, wherein each securing hole (13) is positioned on a plane of symmetry (P1) of an arm (25).
